(19) United States
(12) Patent Application Publication
(10) Pub. No.: US 2010/0017316 A1
(43) Pub. Date: Jan. 21, 2010

(54) AUTOMATED EXPENSE REPORT

(75) Inventors: Shane Joseph, Cobourg (CA); Yvonne Schneider, Houston, TX (US); Federico Serrano, Miami Beach, FL (US); Andrew Stearns, New York, NY (US)

Correspondence Address: Snell & Wilmer L.L.P. (AMEX), ONE ARIZONA CENTER, 400 E. VAN BUREN STREET, PHOENIX, AZ, 85004-2202, US

(73) Assignee: American Express Travel Related Services Company, Inc., New York, NY (US)

(21) Appl. No.: 12/147,790

(22) Filed: Jun. 27, 2008

Related U.S. Application Data
(60) Provisional application No. 60/985,521, filed on Nov. 5, 2007.

(51) Int. Cl. G06Q 20/00; G06Q 10/00; G06Q 30/00

(52) U.S. Cl. 705/34; 705/30; 705/44

(57) ABSTRACT

Creating an expense report automatically by using transactions, business rules and profile information stored by a payment processor is disclosed. The payment processor streamlines and automates the end-to-end expense reporting and reimbursement processes for a company. The review, submission, approval, payment, tracking and reporting associated with employee expense reporting are accomplished by the payment processor through automated, no-touch (or minimal touch) processes.

### CROSS-REFERENCE TO RELATED APPLICATIONS

This application claims priority to, and the benefit of, U.S. Provisional Application Ser. No. 60/985,521 filed Nov. 5, 2007 and entitled “EXPENSE REPORT SYSTEM AND METHOD”, which is hereby incorporated by reference.

### FIELD OF THE INVENTION

The present invention generally relates to leveraging transaction data stored by payment processors to increase process efficiency and, more particularly, to automatically generating employee expense reports and simplifying the end-to-end processing of expense reports.

### BACKGROUND OF THE INVENTION

Expense reporting has traditionally been a stand-alone process initiated by employees who wish to receive reimbursements. The employee is often tasked with tracking expenses, maintaining records of expenses or receipts, determining which expenses qualify for reimbursement, completing forms by listing specific expenses and detailed information about the merchants, submitting the forms for reimbursement and waiting to obtain a reimbursement check. While the employee is waiting to receive a reimbursement check, the employee typically receives the bills for the expenses and is often required to pay the bills prior to receiving the reimbursement from her employer. Employees often use a paper form, or a stand-alone expense report software product, a word processor or spreadsheet software to manually enter expense data from receipts and itineraries, print a report and submit the report to the employer. Such expense report generation processes are complex, cumbersome and time-consuming. A long-felt need exists to minimize data entry requirements, reduce the management of receipts, streamline the overall process and realize cost savings for all entities involved in the process.

### SUMMARY OF THE INVENTION

The present invention improves upon existing systems by providing an end-to-end expense process transformation. The system provides a no-touch (or minimum touch) solution to generating and processing employee expense reports. A user (e.g. an employee) incurs expenses and charges them to a transaction account (e.g., a credit or charge card). At the appropriate time (e.g. the conclusion of a trip and/or the end of the month), the system generates a statement of the transactions charged to the account. The user may then select which charges/items on the statement for which the user requests to be reimbursed. The system then automatically creates an expense report for the user. In one embodiment, the system applies business rules or logic to create the draft expense report. For example, the system may retrieve the data for a pre-approved expense report and match the pre-approved transactions with the transactions on the statement to automatically create the expense report. In one embodiment, the user enters cash and other transactions into the system and those transactions are also automatically included in the expense report. The system notifies the user that the automatically created expense report is ready for review. The user reviews the expense report and verifies that the correct transactions are included in the expense report. The user submits the expense report and the system determines the appropriate approving authority. In one embodiment, the system includes a database with information regarding the organizational structure of an entity (e.g. a company) which is used to determine the appropriate approving authority. The system notifies the approving authority that an expense report is pending approval and receives approval from an authorized approver.

In one embodiment, the system prepares an account statement for a transaction account owned by a user; transmits the account statement to the user; receives a reimbursement request from the user, wherein the reimbursement request identifies a subset of transactions included in the account statement; receives approval of the reimbursement request from an authorized approver; and, debits an account associated with the authorized approver for an amount based upon the subset of transactions, without charging the user for the subset of transactions.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is an overview of a representative system for providing an automated, end-to-end expense reporting tool, in accordance with one embodiment of the present invention.

FIG. 2 is a representative process flow diagram for enabling end-to-end expense reporting, in accordance with one embodiment of the present invention.

FIG. 3 is a representative process flow diagram showing the pre-trip authorization process, in accordance with one embodiment of the present invention.

FIG. 4 is a representative process flow diagram showing the expense report creation and submission process, in accordance with one embodiment of the present invention.

FIG. 5 is a representative process flow diagram showing the expense report approval process, in accordance with one embodiment of the present invention.

FIG. 6 is a representative process flow diagram showing the payment process, in accordance with one embodiment of the present invention.

### DETAILED DESCRIPTION OF EXEMPLARY EMBODIMENTS

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, the system includes a software module, logic engines, computer hardware, numerous databases and computer networks. While the system may contemplate upgrades or reconfigurations of existing processing systems, changes to existing databases and business information system tools are not necessarily required by the present invention.

The exemplary benefits provided by this invention include increased data accuracy, increased time efficiency, reduced operational costs, increased customer satisfaction and improved accounts receivable functions. Because the transactions included in the expense report are retrieved from the user's transaction account, the user does not have to perform cumbersome and error prone data entry and/or data import tasks. Furthermore, the end-to-end processing time is reduced by streamlining and automating pre-approval, submission, approval, notice, payment and audit functions. These efficiencies reduce the overall operational costs associated with a company's time reporting, expense accounting and reimbursement processes and increase satisfaction associated with the services provided by the payment processor. The payment processor benefits from increased spending on the transaction accounts as companies and employees use these transaction accounts more often to pay for their reimbursable expenses. In some cases, approved expenses are reimbursed by not charging (or crediting) the employee transaction account and debiting the company's account, which consolidates receivables and improves collections efficiencies.

While described in the context of systems and methods for enhancing the end-to-end expense reporting process for transaction account customers, practitioners will appreciate that the present invention may be similarly used to enhance functionality, improve data accuracy, increase time efficiency, improve expense transparency, and enhance customer satisfaction in the context of providing an end-to-end automated expense and/or revenue reporting tool to any entity and/or for any expense or revenue reporting process that may benefit from enhanced efficiency, accuracy and audit-ability. Moreover, other embodiments of such automated expense reporting techniques may be accomplished through a variety of computing resources and hardware infrastructures.

While the description makes reference to specific technologies, system architectures and data management techniques, practitioners will appreciate that this description is but one embodiment and that other devices and/or methods may be implemented without departing from the scope of the invention. Similarly, while the description makes frequent reference to a web client, practitioners will appreciate that other examples of transaction authorization requests may be accomplished by using a variety of user interfaces including personal computers, kiosks, handheld devices such as personal digital assistants and cellular telephones.

“Entity” may include any individual, consumer, customer, group, business, organization, government entity, transaction account issuer or processor (e.g., credit, charge, etc), merchant, consortium of merchants, account holder, charitable organization, software, hardware, and/or any other entity or someone acting on behalf of the entity or user.

“Employee” may include any entity and/or anyone who wants to obtain reimbursement for any type of monetary or non-monetary expenses.

An “account”, “account number” or “customer account” as used herein, may include any device, code (e.g., one or more of an authorization/access code, personal identification number (“PIN”), user profile, demographic, Internet code, other identification code, and/or the like), number, letter, symbol, digital certificate, smart chip, digital signal, analog signal, biometric or other identifier/indicia suitably configured to allow the consumer to access, interact with, be identified by or communicate with the system. The account number may optionally be located on or associated with a rewards card, charge card, credit card, debit card, prepaid card, telephone card, secure hardware area or software element associated with a phone or mobile device, embossed card, smart card, magnetic stripe card, bar code card, transponder, radio frequency card or an associated account. The system may include or interface with any of the foregoing cards or devices, or a fob having a transponder and RFID reader in RF communication with the fob. Although the system may include a fob embodiment, the invention is not to be so limited. Indeed, the system may include any device having a transponder which is configured to communicate with an RFID reader via RF communication. Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc.

The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a fifteen-digit format will generally use three-spaced sets of numbers, as represented by the number “0000 000000 00000”. The first five to seven digits are reserved for processing purposes and identify the payment processor, card type, etc. In this example, the last (fifteenth) digit is used as a sum check for the fifteen digit number. The intermediary eight-to-eleven digits are used to uniquely identify the customer. A merchant account number may be, for example, any number or alpha-numeric characters that identify a particular merchant for purposes of card acceptance, account reconciliation, reporting, or the like.

A “transaction account” (“TXA”) may include any account that may be used to facilitate a transaction, e.g. financial, loyalty points, rewards program, barter, access, exchange, etc.

A “TXA issuer” may include any entity which issues accounts, processes transactions (e.g., payment processor), acquires financial information, settles accounts, conducts dispute resolution regarding accounts, and/or the like.

A “payment processor” may include any entity which processes transactions, issues accounts (e.g., TXA issuer), acquires financial information, settles accounts, conducts dispute resolution regarding accounts, and/or the like. For example, a payment processor may provide data transfer capabilities that transfer data from a customer or merchant at a point-of-sale (POS) terminal to the TXA issuer and then back to the POS terminal.

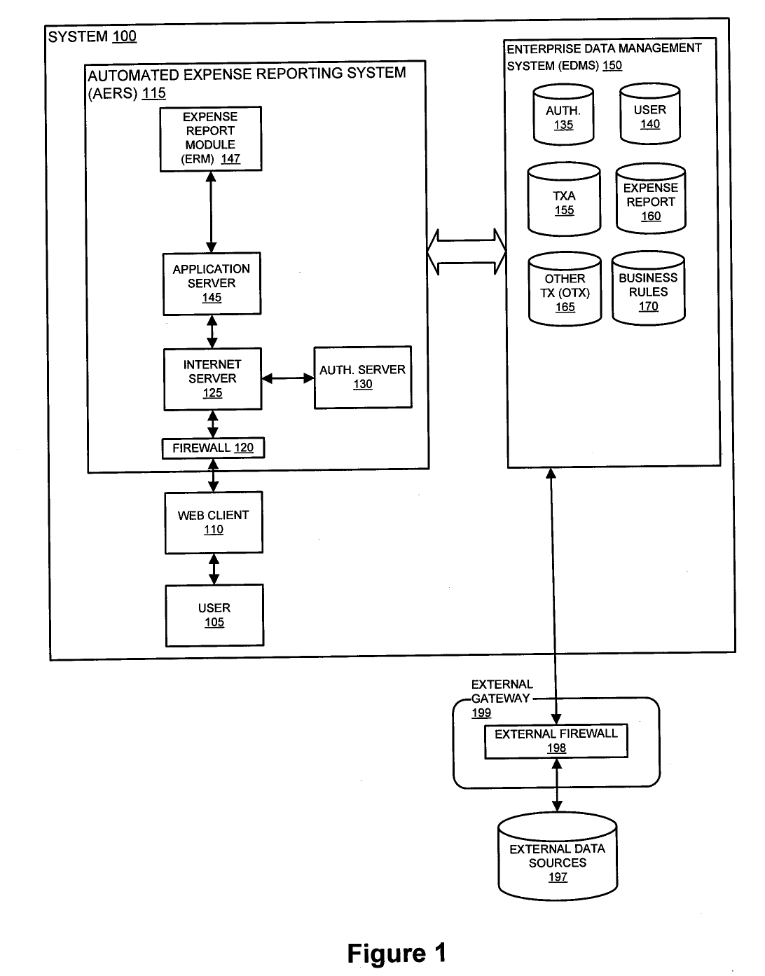

With reference to FIG. 1, in one embodiment, system 100 includes a user 105 interfacing with a automated expense reporting system (“AERS”) 115 by way of a web client 110. User 105 may include any entity that interacts with and/or acts within system 100. User 105 may perform tasks such as requesting, retrieving, receiving, updating, analyzing, entering and/or modifying data. User 105 may be, for example, an employee, reviewing an automatically generated expense report or user 105 may be an administrator accessing AERS 115 to approve expense reports or a third-party conducting audit of employee expenses. User 105 may interface with Internet server 125 via any communication protocol, device or method discussed herein, known in the art, or later developed. In one embodiment, user 105 may interact with AERS 115 via an Internet browser at a web client 110. In one embodiment, user 105 may be, for example, an employee on a business trip that interacts with AERS 115 via a web client 110 that is a mobile device. In one embodiment, user 105 may interact with AERS 115 via proprietary networks, legacy networks, telecommunication networks or other networks and/or communication links that take advantage of protocols other than the typical Internet protocols.

Web client 110 comprises any hardware and/or software suitably configured to facilitate requesting, retrieving, updating, analyzing, entering and/or modifying data. The data may include travel expense data, budget data, authorization data, audit information or any information discussed herein. Web client 110 includes any device (e.g., personal computer or mobile device), which communicates (in any manner discussed herein) with AERS 115 via any network discussed herein. Such browser applications comprise Internet browsing software installed within a computing unit or system to conduct online transactions and communications. These computing units or systems may take the form of a computer or set of computers, although other types of computing units or systems may be used, including: laptops, notebooks, hand held computers, mobile phones, mobile devices, POS devices, kiosks, card authorization devices, RFID reader, set-top boxes, workstations, computer-servers, main frame computers, mini-computers, PC servers, pervasive computers, network sets of computers, and/or the like. Practitioners will appreciate that web client 110 may or may not be in direct contact with AERS 115. For example, web client 110 may access the services of AERS 115 through another server, which may have a direct or indirect connection to Internet server 125.

The invention contemplates uses in association with human resources, finance systems, management information systems, authorization systems, TXA services, payment processor networks, reporting systems, web services, pervasive and individualized solutions, open source, biometrics, mobility and wireless solutions, commodity computing, grid computing and/or mesh computing. For example, in an embodiment, web client 110 is configured with a biometric security system that may be used for providing biometrics as a secondary form of identification. The biometric security system may include a transaction device and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

User 105 may communicate with AERS 115 through firewall 120 to help ensure the integrity of AERS 115 components. Internet server 125 may include any hardware and/or software suitably configured to facilitate communications between web client 110 and one or more AERS 115 components.

Authentication server 130 may include any hardware and/or software suitably configured to receive authentication credentials, encrypt and decrypt credentials, authenticate credentials, and/or grant access rights according to pre-defined privileges attached to the credentials. Authentication server 130 may grant varying degrees of application and data level access to users based on information stored within authentication database 135 and user database 140.

Authentication database 135 may store information used in the authentication process such as, for example, user identifiers, passwords, access privileges, user preferences, user statistics, and the like. User database 140 maintains user information and credentials for AERS 115 users.

Application server 145 may include any hardware and/or software suitably configured to serve applications and data to a connected web client 110. Expense Report Module “ERM” 147 is configured to generate expense reports, and process authorization requests, approvals and payments. ERM 147 functions include, for example, generating an expense report, generating email messages, providing a trip request interface, providing an expense report review interface, and executing approval, payment, analysis and/or audit logic. Additionally, ERM 147 may include any hardware and/or software suitably configured to receive requests from the web client 110 via Internet server 125 and application server 145. ERM 147 is further configured to process requests, receive responses, execute transactions, construct database queries, and execute queries against databases within enterprise data management system (“EDMS”) 150, other system 101 databases, external data sources (“EDS”) 197 and temporary databases, as well as exchange data with other application modules (not pictured). Moreover, ERM 147 may reside as a standalone system or may be incorporated with application server 145 or any other AERS 115 component as program code.

EDMS 150 provides database management and data transport services for all the data residing in an entity's enterprise data architecture, including the data contained therein and elements that deliver data to end users. For example, in one embodiment EDMS 150 is the data management system for a TXA issuer and provides data management services to support the automated expense reporting process.

TXA database 155 includes information regarding current transaction requests, previous transactions and transaction trends. For example, TXA database 155 includes account information, merchant information, amounts, dates and times for financial transactions.

Expense report database 160 includes data used in the expense report process such as, for example, employee profile information, trip itineraries, expense budgets and receipt records.

Other transaction (OTX) database 165 includes transactions that may be included in an expense report other than the transactions stored on TXA database 155. For example, OTX database 170 includes cash transactions for expense paid in cash and expense transactions from other TXA processors or issuers that have been imported from external data sources 197.

Business rules database 170 includes data such as approval hierarchies, organizational structures, audit rules, reporting formats and regulatory and legal rules that are accessed by ERM 147 during various stages of the expense report process.

EDS 197 includes other sources of data that may be useful to support the expense reporting process. For example, transaction data provided by other TXA issuers or other lending institutions.

FIG. 1 depicts databases that are included in an exemplary embodiment of the invention. A representative list of various databases used herein includes: user authentication database 135, user database 140, TXA database 155, expense report database 160, OTX database 165, business rules database 170, EDS 197 and/or other databases that aid in the functioning of the system. As practitioners will appreciate, while depicted as a single entity for the purposes of illustration, these databases may represent multiple hardware, software, database, data structure and networking components. As practitioners will appreciate, embodiments are not limited to the exemplary databases described above, nor do embodiments necessarily utilize each of the disclosed exemplary databases.

In addition to the components described above, system 100, AERS 115, ERM 147, and EDMS 150 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 100 components may be embodied as a customization of an existing system, an add-on product, upgraded software, a stand-alone system (e.g., kiosk), a distributed system, a method, a data processing system, a device for data processing, and/or a computer program product. Accordingly, individual system 100 components may take the form of an entirely software embodiment, an entirely hardware embodiment, or an embodiment combining aspects of both software and hardware. Furthermore, individual system 100 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Web client 110 may include an operating system (e.g., Windows Mobile OS, Windows CE, Palm OS, Symbian OS, Blackberry OS, J2ME, Window XP, Windows NT, 95/98/2000, XP, Vista, OS2, UNIX, Linux, Solaris, MacOS, any next-generation operating system, etc.) as well as various conventional support software and drivers typically associated with mobile devices, computers or other user interfaces. Web client 110 can be in a home or business environment with access to a network including both wireless and wired network connections. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp. Web client 110 may be independently, separately or collectively suitably coupled to the network via data links which includes, for example, a connection to an Internet Service Provider (ISP) over the local loop as is typically used in connection with standard wireless communications networks and/or methods, modem communication, cable modem, Dish networks, ISDN, Digital Subscriber Line (DSL), see, e.g., Gilbert Held, Understanding Data Communications (1996), which is hereby incorporated by reference.

Firewall 120 may comprise any hardware and/or software suitably configured to protect the AERS 115 components from users of other networks. Firewall 120 may reside in varying configurations including stateful inspection, proxy based and packet filtering, among others. Firewall 120 may be integrated as software within Internet server 125, any other system components, or may reside within another computing device or may take the form of a standalone hardware component.

Internet server 125 may be configured to transmit data to the web client 110 within markup language documents. As used herein, “data” may include encompassing information such as commands, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Similar to Internet server 125, the application server 145 may communicate with any number of other servers, databases and/or components through any means known in the art. Further, the application server 145 may serve as a conduit between the web client 110 and the various systems and components of the AERS 115. Internet server 125 may interface with the application server 145 through any means known in the art including a LAN/WAN, for example. Application server 145 may further invoke software modules such as the ERM 147 in response to user 105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (http://yahoo.com/stockquotes/ge) and an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In an embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second parties. Each of the three data sets in this example may contain different information that is stored using different data storage formats and/or techniques. Further, each data set may contain subsets of data that also may be distinct from other subsets.

As stated above, in various embodiments of system 100, the data can be stored without regard to a common format. However, in one embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the TXA issuer, entity, user 105, transaction/membership account identifier, TXA-ID or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 100 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 100 may consist of any combination thereof at a single location or at multiple locations, wherein each database or system includes any of various suitable security features, such as firewalls, access codes, encryption, decryption, compression, decompression, and/or the like.

System 100 may be interconnected to external data sources EDS 197, (for example, to obtain data from a vendor) via a second network, referred to as the external gateway 199. External gateway 199 may include any hardware and/or software suitably configured to facilitate communications and/or process transactions between systems. Although depicted in FIG. 1 as facilitation communication between EDS 197 and EDMS 150, one skilled in the art will appreciate that external gateway 199 may be suitably configured to facilitate communications and/or process transactions between any two systems or sub-systems including system 100, EDMS 150, AERS 115 and the external data sources 197. Interconnection gateways are commercially available and known in the art. External gateway 199 may be implemented through commercially available hardware and/or software, through custom hardware and/or software components, or through a combination thereof. External gateway 199 may reside in a variety of configurations and may exist as a standalone system or may be a software component residing, for example, inside EDMS 150, AERS 115 or any other known configuration. External gateway 199 may be configured to deliver data directly to system 100 components (such as ERM 147) and to interact with other systems and components such as EDMS 160 databases. In one embodiment, external gateway 199 may comprise web services that are invoked to exchange data between the various disclosed systems. External gateway 199 represents existing proprietary networks that presently accommodate data exchange for data such as financial transactions, customer demographics, billing transactions and the like. External gateway 199 is a closed network that is assumed to be secure from eavesdroppers.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language (such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, extensible markup language (XML) and any next-generation programming or scripting language) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

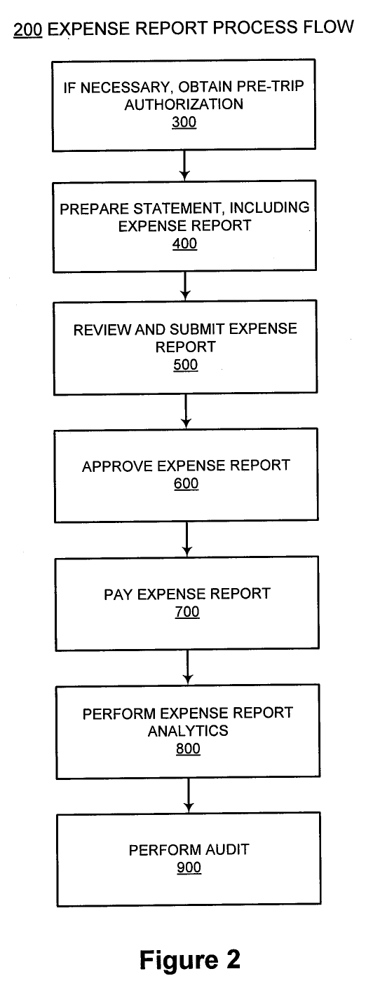

The block system diagrams and process flow diagrams represent mere embodiments of the invention and are not intended to limit the scope of the invention as described herein. For example, the steps recited in FIGS. 2-6 may be executed in any order and are not limited to the order presented. It will be appreciated that the following description makes appropriate references not only to the steps depicted in FIGS. 2-8, but also to the various system components as described above with reference to FIG. 1.

With reference to FIG. 1, in one embodiment, when user 105 logs on to an application, Internet server 125 may invoke an application server 145. Application server 145 invokes logic in ERM 147 by passing parameters relating to user's 105 requests for data. AERS 115 manages requests for data from ERM 147 and communicates with system 100 components such as, for example, EDMS 150 and its associated databases. Transmissions between user 105 and Internet server 125 may pass through a firewall 120 to help ensure the integrity of AERS 115 components. Practitioners will appreciate that the invention may incorporate any number of security schemes or none at all. In one embodiment, Internet server 125 receives data or page requests from web client 110 and interacts with various other system 100 components to perform tasks related to requests from web client 110.

Internet server 125 may invoke an authentication server 130 to verify the identity of user 105 and assign specific access rights to user 105. In order to control access to application server 145 or any other component of AERS 115, Internet server 125 may invoke authentication server 130 in response to user 105 submissions of authentication credentials received at Internet server 125. When a request to access AERS 115 is received by Internet server 125, Internet server 125 determines if authentication is required and transmits a prompt to web client 110. User 105 enters authentication data at web client 110, which transmits the authentication data to Internet server 125. Internet server 125 passes the authentication data to authentication server which queries user database 140 for corresponding credentials. When user 105 is authenticated, user 105 may access various applications and their corresponding data sources.

In one embodiment, user 105 is an employee of a company (“employer”) and both the user 105 and the company have a relationship with a TXA issuer such as, for example, a bank that issues credit cards. User 105 has a TXA with the TXA issuer and uses the TXA to pay for business expenses that are reimbursable by the employer. The employer is also a customer of (or has a relationship with) the TXA issuer. The TXA issuer streamlines and automates the expense reporting, processing, payment, tracking and audit functions of the employer. In one embodiment, TXA issuer provides customized interfaces (e.g. a custom portal) and reports that are tailored to the employer's specifications. In order to enable automation and process efficiencies, the employer's business rules and approval and/or organizational hierarchies are stored in business rules database 170.

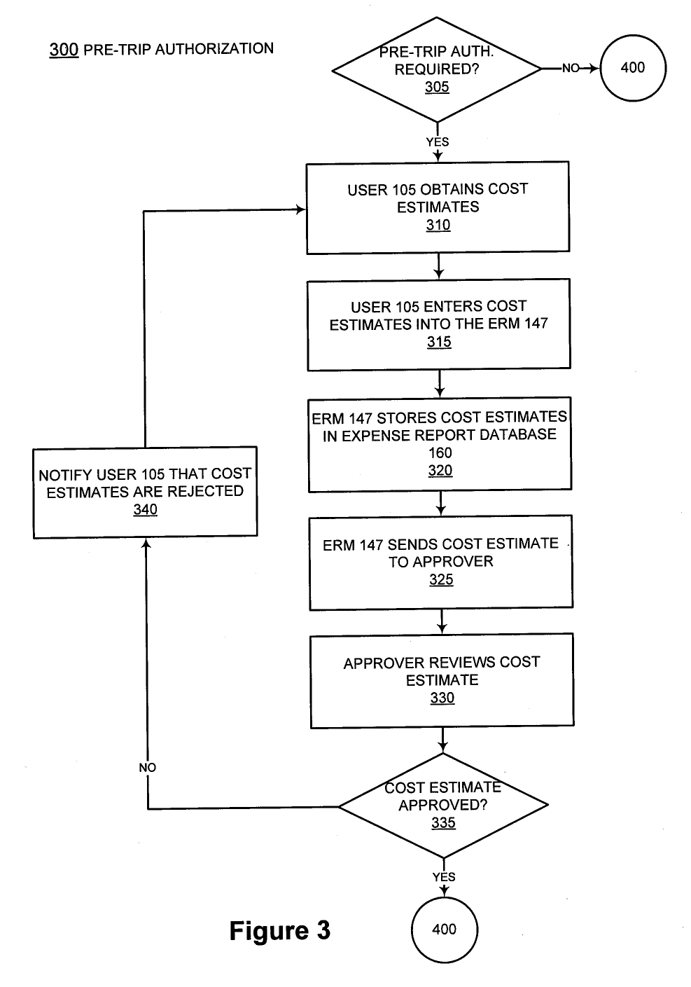

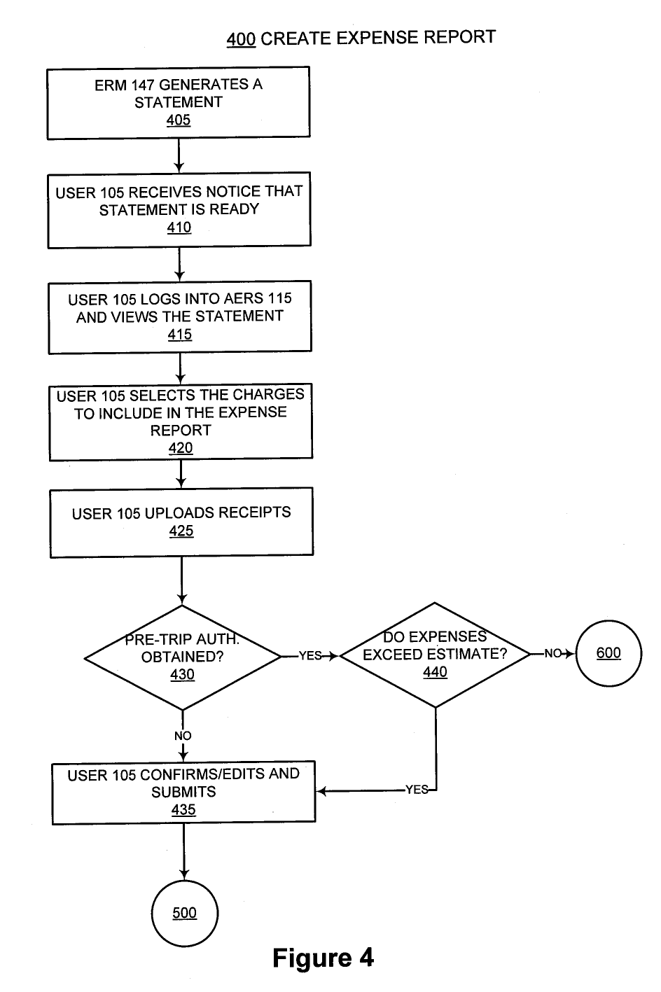

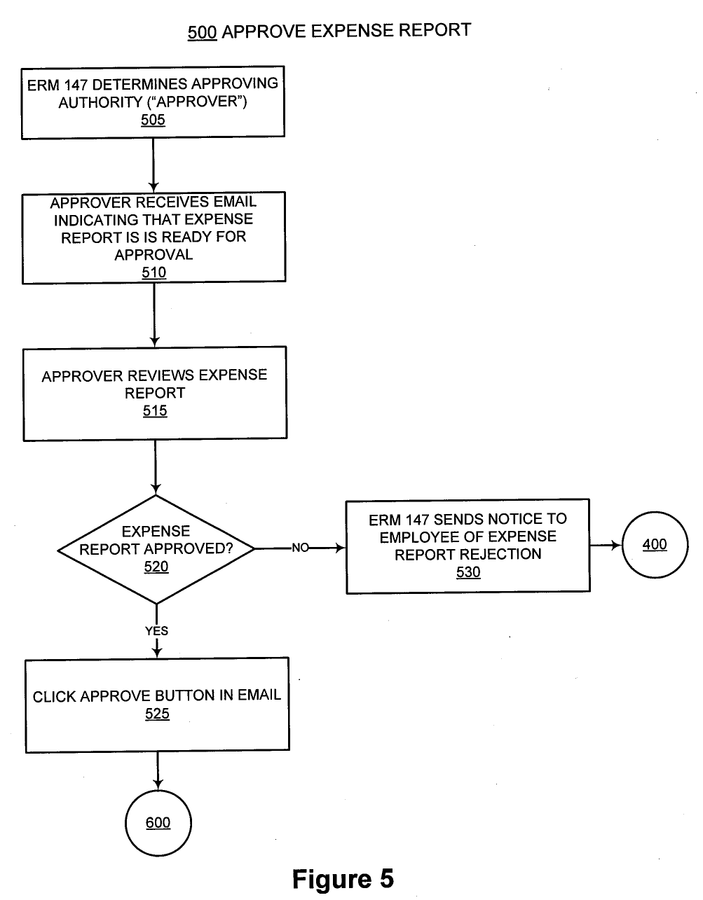

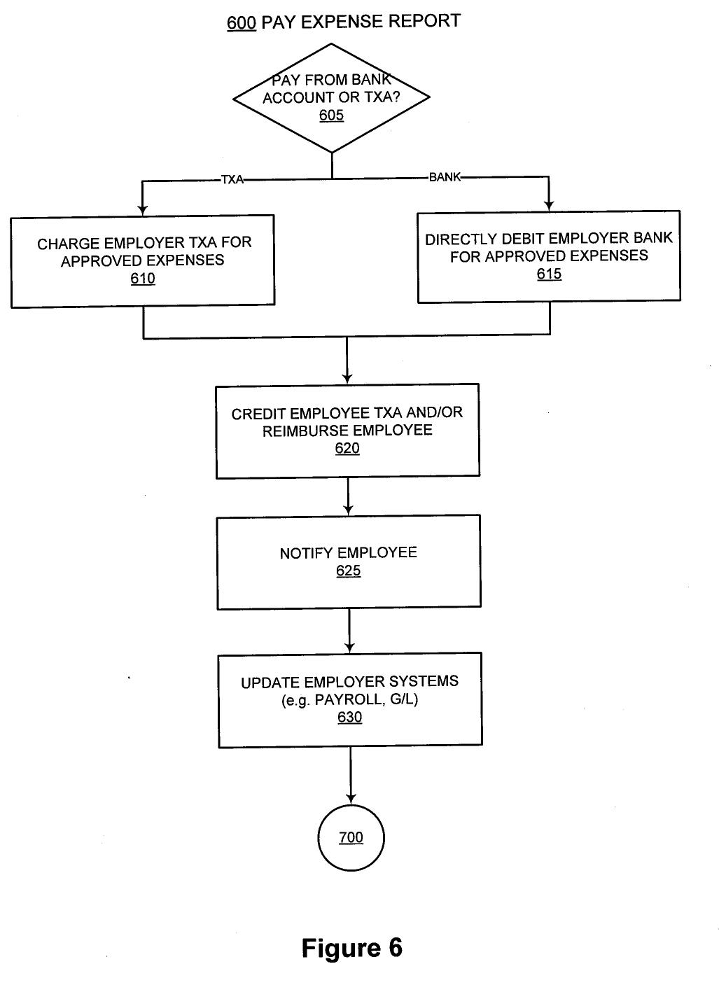

Referring now to FIG. 2, a representative process for enabling end-to-end expense reporting is shown. User 105 (e.g. an employee) obtains a pre-trip authorization to incur business expenses (step 300, see FIG. 3). ERM 147 prepares a statement of transactions on the user's 105 TXA and user 105 reviews the statement and submits an expense report for approval (step 400, see FIG. 4). The expense report is approved (step 500, see FIG. 5) and payment is made to reimburse user 105 (step 600, see FIG. 6). Expense report data is stored in expense report database 160 to enable tracking, analytics and audit functionality. Periodically, user 105 (e.g. a management level employee) accesses AERS 115 and generates reports useful in analyzing expenses and expense related activity (step 700). Periodically, management accesses AERS 115 to conduct audit functions (step 800). In one embodiment, user 105 is a third-party accessing the AERS 115 to conduct audit functions.

Referring now to FIG. 3, a representative process flow diagram for the pre-trip authorization process is shown. In one embodiment, user 105 may not obtain pre-trip authorization. In such embodiments, the budget for various expenses may be set by policies stored in business rules database 170. If pre-trip authorization is to be obtained (step 305), user 105 obtains cost estimates (step 310) and enters them into ERM 147 (step 315). Estimates for expenses may be stored in business rules database 170 such as, for example, when a company has established pre-negotiated rate for a rental car. In one embodiment, AERS 115 assists user 105 in obtaining expense estimates by, for example, providing quotes for airline travel or hotels that are obtained from external data sources 197. The pre-trip authorization request is stored in expense report database 160 (step 320).

ERM 147 sends pre-trip authorization cost estimates to an approver who is typically another employee of the same entity (step 325). In one embodiment, the approver is a third-party or a software module. The approver reviews the cost estimates (step 330) and either approves or rejects the pre-trip authorization request. If the pre-trip authorization request is rejected, ERM 147 notifies user 105 (step 340) and the user obtains new cost estimates (step 310). In one embodiment, the budgeted or pre-authorized amounts for typical business expenses (e.g. per mile reimbursement rate for automobile travel) are stored in business rules database 170. The approval of the pre-trip authorization request is fully, or partially, automated and ERM 147 adjusts the pre-trip authorization request cost estimates accordingly. In one embodiment, if items in the cost estimate are adjusted to comply with business rules, the adjusted cost estimate is automatically approved (step 335) and ERM 147 notifies (e.g. by sending an email message) user 105 of the adjustments made to the cost estimates.

Referring now to FIG. 4, the expense report creation and submission process is shown. This process is accomplished by implementing new custom built software modules or by integrating the capabilities of an existing custom built or commercially available tool or system. ERM 147 generates a statement of the transactions that have occurred in user's 105 TXA (step 405). ERM 147 generates the statement periodically (e.g. monthly), on demand, as triggered by the occurrence of an event and/or as governed by a business rule. In one embodiment, ERM 147 applies business rules, prediction methods and/or logic to automatically create an expense report. In one embodiment, ERM 147 matches transactions on the TXA with the items on the pre-authorization request in order to automatically create the expense report. If user 105 incurs reimbursable expenses and pays for the expense with cash then user 105 logs into AERS 115 to enter the cash expenditures and proof of the expenditures (e.g., receipts as PDFs) which are stored on OTX database 165. In one embodiment, EDMS 150 invokes logic to retrieve expenses from other transaction accounts which may be maintained, for example, by a third-party. In one embodiment, external systems are configured to automatically send (i.e. push) data to EDMS 150. Expenses incurred on other financial transaction instruments (i.e. not on user's 105 TXA) are stored in OTX database 165.

In one embodiment, AERS 115 integrates the capabilities of an existing expense reporting tool such as, for example, a custom built module or a commercial-off-the shelf tool (e.g. Concur™, Gelco Expenselink®, etc.). ERM 147 receives, analyzes, processes and/or formats expense data from TXA database 155, Expense Report database 160, OTX database 165 or other data sources so that the data can be imported by the existing expense reporting tool. ERM 147 causes the statement to be generated by invoking the expense reporting tool, executing a programming interface of the tool or by otherwise triggering the expense reporting tool.

User 105 (e.g. an employee) receives notice that the TXA statement is ready (step 410). User 105 logs into AERS 115 and views the statement and/or the automatically generated expense report (step 415). User 105 reviews the charges on the statement and selects charges to include in the expense report (step 420). User 105 uploads receipts (step 420). ERM 147 retrieves data from expense report database 160 and executes logic to determine whether pre-trip authorization for the selected expenses was obtained (step 430). If pre-trip authorization was not obtained, then user 105 confirms and/or edits the items on the expense report and submits it for approval (step 435). If pre-trip authorization was obtained then ERM 147 determines whether the expenses are less than or equal to the pre-approved amount and automatically approves or rejects the expense report accordingly (step 440). In one embodiment, ERM 147 accesses business rules and/or executes logic to match individual expenses or expense categories with the line items in the approved pre-trip authorization and approves or rejects on an item by item, and/or category by category, basis. If the expenses are rejected (step 440), then user 105 confirms and/or edits the items on the expense report and submits it for approval (step 435).

Referring now to FIG. 5, a representative process flow diagram of the expense report approval process is shown. ERM 147 reads expense report database 160. If there are any unapproved expense reports, ERM 147 reads business rules database 170 to determine the appropriate approving authority (the “approver”) for the expense report (step 505). In one embodiment, the organizational and/or hierarchical structure of an entity is stored in business rules database 170, along with rules that determine the appropriate approving authority for a given employee. ERM 147 notifies user 105 (i.e. the approver) that an expense report approval is pending (step 510). In one embodiment, the approver is notified via an email automatically generated by ERM 147. User 105 logs into the AERS 115 and reviews the expense report (step 515). The approval process is fully automated; to indicate approval (step 520), the approver clicks a button which is presented on the same screen as the expense report (step 525). If the expense report is not approved (step 520), the approver clicks a different button and ERM 147 notifies the employee that the expense report is rejected (step 530).

Referring now to FIG. 6, a representative process flow diagram showing the payment process is shown. ERM 147 partially or completely automates the payment of reimbursable expenses. ERM 147 may execute payment process 600 periodically based upon a pre-defined schedule, on demand and/or as triggered by an event such as the approval of an expense report. ERM 147 reads the employer profile stored on business rules database 170 and determines the employer reimbursement preferred method (step 605). If the expense report is to be paid by charging the employer TXA, ERM 147 submits a charge for the total reimbursable amount to the employer TXA (step 610). If the expense report is to be paid by directly debiting the employer's bank, ERM 147 executes the appropriate transaction (e.g. an ACH transaction) (step 615). ERM 147 credits the employee TXA for the total reimbursable expenses that were originally paid using the employee TXA (step 620).

ERM 147 requests a reimbursement check for the employee for the reimbursable expenses that were not originally incurred on the employee TXA (step 620). For example, if the employee paid for air travel, hotel and car with their TXA and paid for meals using cash, the employee is credited on the TXA for the air, hotel and car expenses and receives a reimbursement check for the cash. In one embodiment, ERM 147 credits the employee TXA with the total reimbursable amount. ERM 147 notifies the employee of the reimbursement activity (i.e. TXA credit and/or check request) using, for example, email, text message and/or system message (step 625). ERM 147 updates the employer systems such as, for example, payroll and the general ledger (step 630).

Referring again to FIG. 3, in one embodiment, reimbursed expenses are itemized and/or categorized and submitted to the employer financial systems to enable automated and comprehensive reporting (step 700) and audit functions (step 800).

While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

1. A method for expense reimbursement processing comprising:
preparing an account statement for a transaction account owned by a user;
transmitting the account statement to the user;
receiving a reimbursement request from the user, wherein the reimbursement request identifies a subset of transactions included in the account statement;
receiving approval of the reimbursement request from an authorized approver; and,
debiting an account associated with the authorized approver for an amount based upon the subset of transactions.

2. The method of claim 1, wherein the authorized approver is at least one of: an administrator, an entity, a software module and an accounting system.

3. The method of claim 1, wherein without charging the user for the subset of transactions includes removing the charges related to the subset of transactions from the transaction account.

4. The method of claim 1, wherein the account statement is a billing statement related to a transaction account.

5. The method of claim 1, wherein the reimbursement request is an expense report.

6. The method of claim 1, wherein receiving approval comprises retrieving a pre-approval amount and comparing the pre-approval amount with the amount of the reimbursement request.

7. The method of claim 1, wherein receiving approval comprises confirming that the subset of transactions conform to pre-approved transactions.

8. The method of claim 1, wherein receiving approval comprises confirming that the subset of transactions conform to business rules.

9. The method of claim 1, further comprising determining an appropriate authorized approver.

10. The method of claim 1, wherein receiving the reimbursement request comprises receiving additional transactions from the user as part of the reimbursement request.

11. The method of claim 1, wherein receiving the reimbursement request comprises receiving additional transactions from the user as part of the reimbursement request, wherein the additional transactions include proof of the expense.

12. The method of claim 1, wherein receiving the reimbursement request comprises receiving additional transactions from the user as part of the reimbursement request, wherein the additional transactions are not associated with at least one of the transaction account and the account statement.

13. The method of claim 1, wherein preparing the account statement comprises adding transactions from multiple transaction accounts.

14. The method of claim 1, wherein preparing the account statement comprises adding transactions from multiple payment processors.

15. The method of claim 1, wherein debiting the account associated with the authorized approver comprises not charging the user for the subset of transactions.

16. The method of claim 1, wherein debiting the account associated with the authorized approver comprises invoicing the authorized approver.

17. The method of claim 1, further comprising crediting the transaction account for the amount based upon the subset of transactions.

18. The method of claim 1, further comprising crediting a second transaction account for at least a portion of the amount based upon the subset of transactions.

19. The method of claim 1, further comprising sending a check for the amount based upon the subset of transactions.

20. A method for expense reimbursement processing comprising:
identifying a subset of transactions on an account statement for a first transaction account owned by a user; and,
sending a reimbursement request to a payment processor, wherein the reimbursement request identifies the subset of transactions identified in the account statement, wherein the payment processor receives approval of the reimbursement request from an authorized approver and debits an account associated with the authorized approver for an amount based upon the subset of transactions.

21. A method for expense reimbursement processing comprising:
sending approval of a reimbursement request to a payment processor, wherein the payment processor received the reimbursement request from a user, wherein the reimbursement request identifies a subset of transactions included in an account statement, and wherein the payment processor debits an account associated with the authorized approver for an amount based upon the subset of transactions; and,
receiving a debit of an account for an amount based upon the subset of transactions.
